(19) United States
(12) Patent Application Publication
(10) Pub. No.: US 2013/0060810 A1
(43) Pub. Date: Mar. 7, 2013

(54) SMART DATABASE CACHING

(71) Applicants: David Maman, Tel Aviv-Yafo (IL); Yuli Stremovsky, Petah Tiqwa (IL)

(72) Inventors: David Maman, Tel Aviv-Yafo (IL); Yuli Stremovsky, Petah Tiqwa (IL)

(73) Assignee: GREEN SQL LTD, Tel Aviv-Yafo (IL)

(21) Appl. No.: 13/698,069

(22) PCT Filed: May 17, 2011
(86) PCT No.: PCT/IB2011/052150

§ 371 Date: Nov. 15, 2012

Related U.S. Application Data
(60) Provisional application No. 61/345,166, filed on May 17, 2010.

(51) Int. Cl. G06F 17/30

(52) U.S. Cl. 707/769; 707/E17.014

(57) ABSTRACT

A system and method for smart caching, in which caching is performed according to one or more functional criteria, in which the functional criteria includes at least time elapsed since a query was received for the data. Preferably at least data is cached.

### FIELD OF THE INVENTION

The present invention is of a system and method for smart database caching and in particular, such a system and method in which data is selected for caching according to one or more functional criteria.

### BACKGROUND OF THE INVENTION

Relational databases, and their corresponding management systems, are very popular for storage and access of data. Relational databases are organized into tables which consist of rows and columns of data. The rows are formally called tuples. A database will typically have many tables and each table will typically have multiple tuples and multiple columns. The tables are typically stored on direct access storage devices (DASD) such as magnetic or optical disk drives for semi-permanent storage.

Typically, such databases are accessible through queries in SQL, Structured Query Language, which is a standard language for interactions with such relational databases. An SQL query is received by the management software for the relational database and is then used to look up information in the database tables. Management software which uses dynamic SQL actually prepares the query for execution, only after which the prepared query is used to access the database tables. Preparation of the query itself can be time consuming. Furthermore, any type of query communication (including both transmission of the query itself and of the answer) also requires bandwidth and time, in addition to computational processing resources. All of these requirements can prove to be significant bottlenecks for database operational efficiency.

Various attempts have been made to improve the efficiency of database operations. Some attempts have focused on increasing the efficiency of the database look-up process, although this does not address the above problems of bandwidth or processing resources. Other attempts have focused upon the overall operation of the database. For example, U.S. Pat. No. 5,465,352 relates to a method for a database “assist”, in which various database operations are performed outside of the database so that the results can be returned more quickly. Again, this method does not address the above problems of bandwidth and overall computational resources.

U.S. Pat. No. 6,115,703 relates to a two-level caching system for a relational database which uses dynamic SQL. As noted above, queries for dynamic SQL require preparation which can be costly in terms of time and computational resources. The two-level caching system stories the prepared queries themselves (ie the executable structures for the queries) so that they can be reused if a new query is received and is found to be executable using the previously prepared executable structure. Again, this method does not address the above problems of bandwidth and overall computational resources.

### SUMMARY OF THE INVENTION

There is thus an unmet need for, and it would be highly useful to have, a system and method for improving the efficiency of database operations in terms of both computational resources and bandwidth.

The present invention overcomes the deficiencies of the background art by providing a system and method for smart caching, in which caching is performed according to one or more functional criteria. Preferably at least data is cached, although more preferably the query is stored with the resultant data. For database software operating with dynamic SQL, optionally an executable query may be stored. By “functional criteria” it is meant time elapsed since a previous query which retrieves the same data was received, in which the elapsed time is optionally adjustable according to one or more characteristics of the query and/or of the retrieved data, the number of times that the data has been retrieved, the frequency of retrieval and so forth.

According to some embodiments of the present invention, the system features a smart cache apparatus in communication with a database, which may optionally be incorporated within the database but is alternatively (optionally and preferably) provided as a separate entity from the database. The smart cache apparatus preferably acts as a “front end” to the database, thereby reducing bandwidth and increasing performance. For example, the smart cache apparatus preferably has a separate port or separate network address, such as a separate IP address (if the smart cache apparatus is operated by hardware that is separate from the hardware operating the database), such that queries are addressed to the port and IP address of the smart cache apparatus, rather than directly to the database. Furthermore, optionally a plurality of smart cache apparatuses may interact with a particular database, which may further increase the efficiency and speed of data retrieval.

Without wishing to provide a closed list, the above system and method overcome the drawbacks of the background art by reducing bandwidth and general network traffic as well as computational resources for database operation. In addition, the above system and method provide more efficient overall operations and increased rapidity of data retrieval.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative non-limiting system according to some embodiments of the present invention;

FIG. 2 shows an alternative, illustrative exemplary system according to at least some embodiments of the present invention, in which the smart caching apparatus is incorporated within the operating system which holds the database as well;

FIG. 3 is a flowchart of an exemplary, illustrative method for operation of a smart caching apparatus according to at least some embodiments of the present invention;

FIG. 4 describes an exemplary, illustrative method according to at least some embodiments of the present invention for automatically requesting flushed or about to be flushed data from the back end database;

FIG. 5 describes an exemplary, illustrative method according to at least some embodiments of the present invention for translating different database protocols automatically at the smart caching interface;

FIG. 6 shows an alternative, illustrative exemplary system for database mirroring according to at least some embodiments of the present invention;

FIG. 7 is a flowchart of an exemplary method for database mirroring according to at least some embodiments of the present invention;

FIG. 8 is a flowchart of an exemplary method for dynamic process analysis according to at least some embodiments of the present invention; and

FIG. 9 is a flowchart of an exemplary method for automatic query updates according to at least some embodiments of the present invention.

### DESCRIPTION OF THE PREFERRED EMBODIMENTS

The present invention is of a system and method for smart caching, in which caching is performed according to one or more functional criteria, in which the functional criteria includes at least time elapsed since a query was received for the data. Preferably at least data is cached.

According to some embodiments of the present invention, the system features a smart cache apparatus in communication with a database, which may optionally be operated by the same hardware as the database (for example by the same server), but is alternatively (optionally and preferably) provided as a separate entity from the database. The smart cache apparatus preferably acts as a “front end” to the database, thereby reducing bandwidth and increasing performance. For example, the smart cache apparatus preferably has a separate port or separate network address, such as a separate IP address (if the smart cache apparatus is operated by hardware that is separate from the hardware operating the database), such that queries are addressed to the port and IP address of the smart cache apparatus, rather than directly to the database. Furthermore, optionally a plurality of smart cache apparatuses may interact with a particular database, which may further increase the efficiency and speed of data retrieval.

In any case, the smart cache apparatus preferably receives queries from a query generating application, which would otherwise be sent directly to the database. The smart cache apparatus then determines whether the data for responding to the query has been stored locally to the smart cache apparatus; if it has been stored, then the data associated with the query is preferably retrieved. After a period of time has elapsed, which may be adjusted according to one or more parameters as described in greater detail below, the stored data is preferably flushed.

However, according to at least some embodiments of the present invention, a hash or other representation of the response to the query is preferably stored, even after the data is flushed. The hash for example could optionally be an MD5 hash.

According to at least some embodiments of the present invention, optionally and preferably one or more queries are not cached, and optionally are defined as never being cached, such that each time the source application executes this query or these queries, the caching apparatus executes the query to the back end database. The determination of whether to enable or disable caching may optionally be performed according to one or more parameters including but not limited to one or more characteristics of the query, one or more characteristics of the database itself, the requesting application source IP address and so forth. Furthermore such one or more parameters may optionally be provided as part of the caching apparatus configuration options, for example.

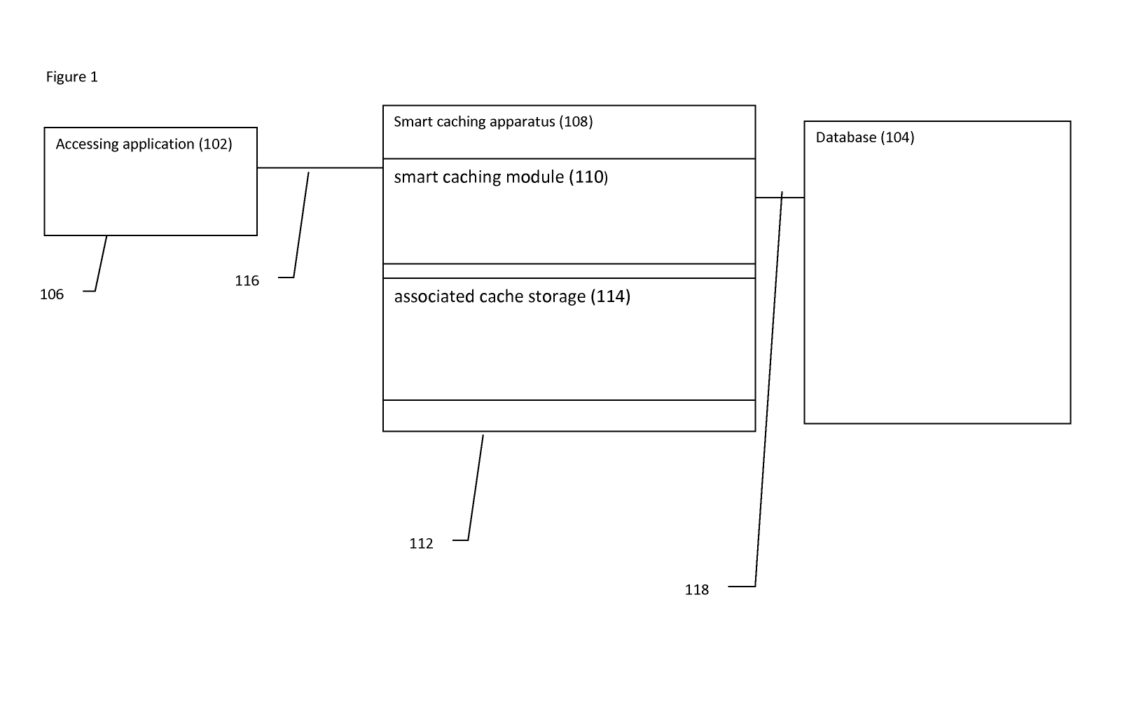

Referring now to the drawings, FIG. 1 shows an exemplary, illustrative non-limiting system according to some embodiments of the present invention. As shown, a system 100 features an accessing application 102 for providing a software application interface to access a database 104. Accessing application 102 may optionally be any type of software, or many optionally form a part of any type of software, for example and without limitation, a user interface, a back-up system, web applications, data accessing solutions and data warehouse solutions. Accessing application 102 is a software application (or applications) that is operated by some type of computational hardware, shown as a computer 106. However, optionally computer 106 is in fact a plurality of separate computational devices or computers, any type of distributed computing platform and the like; nonetheless, a single computer is shown for the sake of clarity only and without any intention of being limiting.

Similarly, database 104 is a database software application (or applications) that is operated by some type of computational hardware, shown as a computer 108. Again, optionally computer 108 is in fact a plurality of separate computational devices or computers, any type of distributed computing platform and the like; nonetheless, a single computer is shown for the sake of clarity only and without any intention of being limiting.

In a typical prior art system, accessing application 102 would communicate directly with database 104. However, in this illustrative embodiment of the present invention, accessing application 102 communicates with database 104 through a smart caching apparatus 108. Smart caching apparatus 108 preferably comprises a software application (or applications) for smart caching, shown as a smart caching module 110, operated by a computer 112, and an associated cache storage 114, which could optionally be implemented as some type of memory (or a portion of memory of computer 112, for example if shared with one or more other applications, in which an area is dedicated to caching). Smart caching apparatus 108 may optionally be implemented as software alone (operated by a computer as shown), hardware alone, firmware alone or some combination thereof. Again, if present, optionally computer 112 is in fact a plurality of separate computational devices or computers, any type of distributed computing platform and the like; nonetheless, a single computer is shown for the sake of clarity only and without any intention of being limiting.

As described in greater detail below, smart caching apparatus 108 preferably receives database queries from accessing application 102, which would otherwise have been sent directly to database 104. For example, a database query is sent from accessing application 102. Smart caching apparatus 108 preferably receives this query instead of database 104. The query is passed to smart caching module 110, which compares this query to one or more queries stored in associated cache storage 114. If the query is not found in associated cache storage 114, then the query is passed to database 104.

Smart caching apparatus 108 also preferably receives the response from database 104. The response and the query are then stored in associated cache storage 114 according to one or more functional criteria. The functional criteria relates to time elapsed since a previous query which retrieves the same data was received, in which the elapsed time is optionally adjustable according to one or more parameters. As described in greater detail below, the one or more parameters are related to the query, the data provided in response, the type or identity of accessing application 102, bandwidth availability between accessing application 102 and smart caching apparatus 108, and so forth. Therefore data is preferably stored in associated cache storage 114 for a period of time. After the period of time, the response and query are preferably both flushed from associated cache storage 114; however, optionally and preferably, a hash of the data is stored, such as a MD5 hash.

However, if another query which results in the same data being provided is received by smart caching apparatus 108 within the predetermined period of time, the stored data in associated cache storage 114 is preferably provided to accessing application 102 as applicable directly from smart caching apparatus 108, without any communication with database 104. As described in greater detail below, the data and query are stored for a period of time according to one or more functional criteria; the hash may optionally be used as a marker for the data, in order to determine how many times and/or the rate of retrieval of the particular data, also as described in greater detail below.

Smart caching apparatus 108, accessing application 102 and database 104 preferably communicate through some type of computer network, although optionally different networks may communicate between accessing application 102 and smart caching apparatus 108 (as shown, a computer network 116), and between smart caching apparatus 108 and database 104 (as shown, a computer network 118). For example, computer network 116 may optionally be the Internet, while computer network 118 may optionally comprise a local area network, although of course both networks 116 and 118 could be identical and/or could be implemented according to any type of computer network.

In this embodiment of the system 100 according to the present invention, smart caching apparatus 108 preferably is addressable through both computer networks 116 and 118; for example, smart caching apparatus 108 could optionally feature an IP address for being addressable through either computer network 116 and/or 118.

Database 104 may optionally be implemented according to any type of database system or protocol; however, according to preferred embodiments of the present invention, database 104 is implemented as a relational database with a relational database management system. Non-limiting examples of different types of databases include SQL based databases, including but not limited to MySQL, Microsoft SQL, Oracle SQL, postgreSQL, and so forth.

These embodiments with regard to different database types may also optionally be applied to any of the embodiments of the system according to the present invention as described herein.

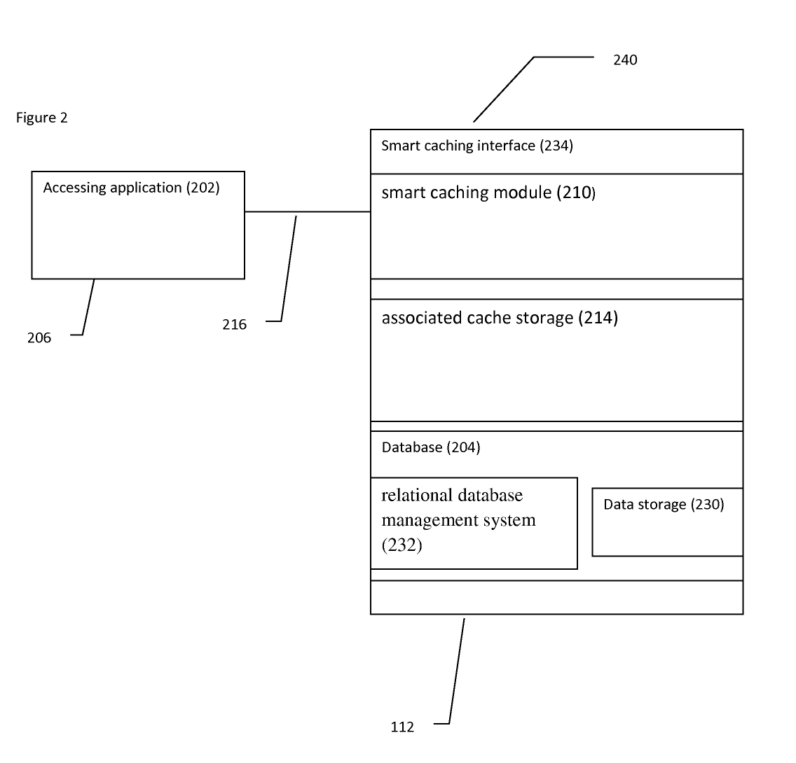

FIG. 2 shows an alternative, illustrative exemplary system according to at least some embodiments of the present invention, in which the smart caching apparatus is operated by the same hardware as the database; the hardware may optionally be a single hardware entity or a plurality of such entities. For this exemplary system, the database is shown as a relational database with a relational database management system for the purpose of illustration only and without any intention of being limiting. Components with the same or similar function are shown with the same reference number plus 100 as for FIG. 1.

A system 200 again features an accessing application 202 and a database 204. Database 204 is preferably implemented as a relational database, with a data storage 230 having a relational structure and a relational database management system 232. Accessing application 202 addresses database 204 according to a particular port; however, as database 204 is operated by a server 240 as shown, accessing application 202 sends the query to the network address of server 240.

Unlike for the system of FIG. 1, a smart caching interface 234 is preferably running over the same hardware as database 204, optionally by single server 240 as shown or alternatively through distributed computing, rather than being implemented as a separate apparatus. Therefore, smart caching interface 234 again preferably features smart caching module 210 and associated cache storage 214, but is preferably not directly addressable. Instead, all queries are preferably received by database 204. However, the operation is preferably substantially similar to that of the smart caching apparatus of FIG. 1.

Smart caching interface 234 and accessing application 202 preferably communicate through a computer network 218, which may optionally be implemented according to any type of computer network as described above. Also as noted above, accessing application 202 sends the query for database 204 to the network address of server 240. The query is sent to a particular port; this port may optionally be the regular or “normal” port for database 204, in which case smart caching interface 234 communicates with database 204 through a different port. Otherwise, accessing application 202 may optionally send the query to a different port for smart caching interface 234, so that smart caching interface 234 communicates with database 204 through a different port.

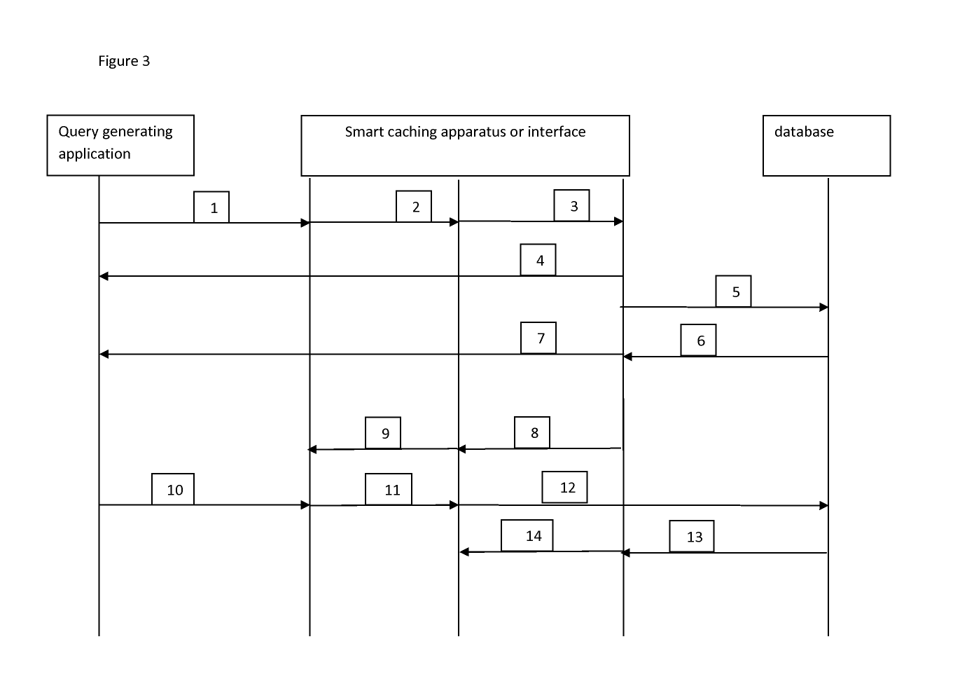

FIG. 3 is a flowchart of an exemplary, illustrative method for operation of a smart caching apparatus according to at least some embodiments of the present invention, with interactions between the accessing application, smart caching apparatus or interface, and the database. Arrows show the direction of interactions. As shown, in stage 1, a query is transmitted from some type of query generating application, shown as the accessing application as a non-limiting example only, and is sent to the smart caching apparatus or interface. As described above, the query generating application may optionally be any type of application, such as for example the accessing application of FIG. 1 or 2.

In stage 2, the smart caching apparatus or interface preferably compares the received query to one or more stored queries, which are preferably stored locally to the smart caching apparatus or interface. In stage 3, if the received query matches a stored query, then the data associated with the stored query is preferably retrieved. In stage 4, the retrieved data is preferably returned to the query generating application.

However, if the received query does not match a stored query, then the smart caching apparatus or interface preferably passes the query to the database in stage 5. The database returns the query results (ie data) to the smart caching apparatus or interface in stage 6.

The smart caching apparatus or interface then preferably determines whether the results should be stored at all. It is possible that some types of queries and/or results are not stored, whether due to the nature of the query and/or the result, the nature of the query generating application, the nature of the database and so forth. For example, if the results are for the exact amount of money in a bank account, it may be determined that the results are not to be stored. However, for all other cases, preferably the results are stored and if so, then preferably the below process is performed (the results are in any case also preferably returned to the query generating application in stage 7). In stage 8, the data and query are preferably stored for a minimum period of time, preferably with a timestamp to determine time of storage. Once this period of time has elapsed, then the data and query are preferably flushed in stage 9. However, a hash of the data, such as the MD5, is preferably stored.

Of course, alternative and/or additional factors may optionally determine when the data and query are to be flushed (ie, when their “TTL” or time to live has expired). The maximum value of the permitted elapsed time between receipts of a query resulting in the provision of particular results is optionally and preferably determined by an administrator or other policy setting entity.

Once the data has been flushed, preferably the below process is performed. In stage 10, a new query is received from the query generating application, which is not stored at the smart caching apparatus or interface, as determined in stage 11. Therefore, a request for the data is sent to the database in stage 12 and is returned in stage 13. However, the hash of the results is found to match a hash stored at the smart caching apparatus or interface, therefore in stage 14, optionally the results from the query are stored at the smart caching apparatus or interface for a longer period of time (such a matching of the hash may optionally need to occur more than once for the TTL of the stored results to be increased). In any case, the results are returned to the query generating application (not shown).

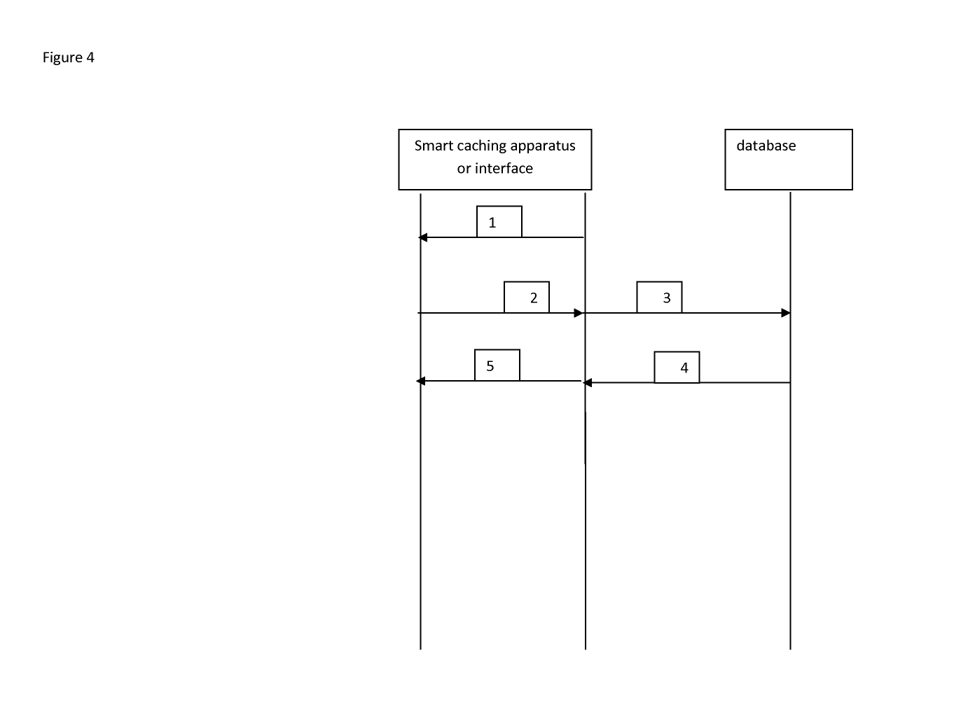

Each subsequent time that a query is sent from the query generating application, it is received by the smart caching apparatus or interface, and it is determined whether the received query matches a stored query. If so, not only is the stored data returned, but preferably the TTL (time to live) of the stored data is increased, so that it is stored for longer and longer periods of time, optionally and more preferably up to some maximum ceiling (which is optionally and preferably determined by an administrator or other policy setting entity), such that after the maximum period of time has elapsed, the data is flushed anyway. However, if the maximum period of time elapses, optionally and preferably the following process is performed, as shown in FIG. 4.

In stage 1, it is determined that the data to be flushed is preferably to be restored automatically, without waiting for a query from the query generating application (not shown). Preferably this determination is performed according to a functional characteristic of the data, which may optionally relate (as previously described) to one or more of a characteristic of the data itself, a characteristic of the query, In stage 2, the data is flushed. In stage 3, a request is sent to the database with the query that previously caused the data that was previously flushed to be sent; however this data of course could be updated or otherwise changed when returned by the database in stage 4. In stage 5, the newly sent data is preferably stored at the smart caching apparatus or interface, even without receipt of a request from the query generating apparatus (not shown) requesting the data.

For FIG. 3 or 4, if a plurality of databases are in communication with a particular smart caching apparatus or interface (not shown), then the configuration may optionally be different for each database regarding time to store data before flushing and/or any of the other above described parameters.

Also for FIG. 3 or 4, optionally caching enforcement according to at least some embodiments of the present invention, in which data is kept in the smart caching apparatus or interface if the database is not available. Preferably the latest data is not flushed (ie the TTL is extended such that the data remains stored) until contact with database is restored. Such caching enforcement may optionally also be used under other circumstances, which are preferably selected by the administrator or other policy maker, for example for situations including but not limited to database restart, restore, update etc and so forth. For any of these situations optionally all data stored or alternatively, data can be stored by category.

The above described smart caching apparatus (or interface) is preferably adjusted for different types of databases. Non-limiting examples of different types of databases include 3D databases, flat file databases, hierarchical databases, object databases or relational databases. The smart caching apparatus (or interface) is preferably also adjusted for different types of database languages for any given type of database. Optionally, according to at least some embodiments of the present invention, a protocol parser is provided, as described in greater detail below.

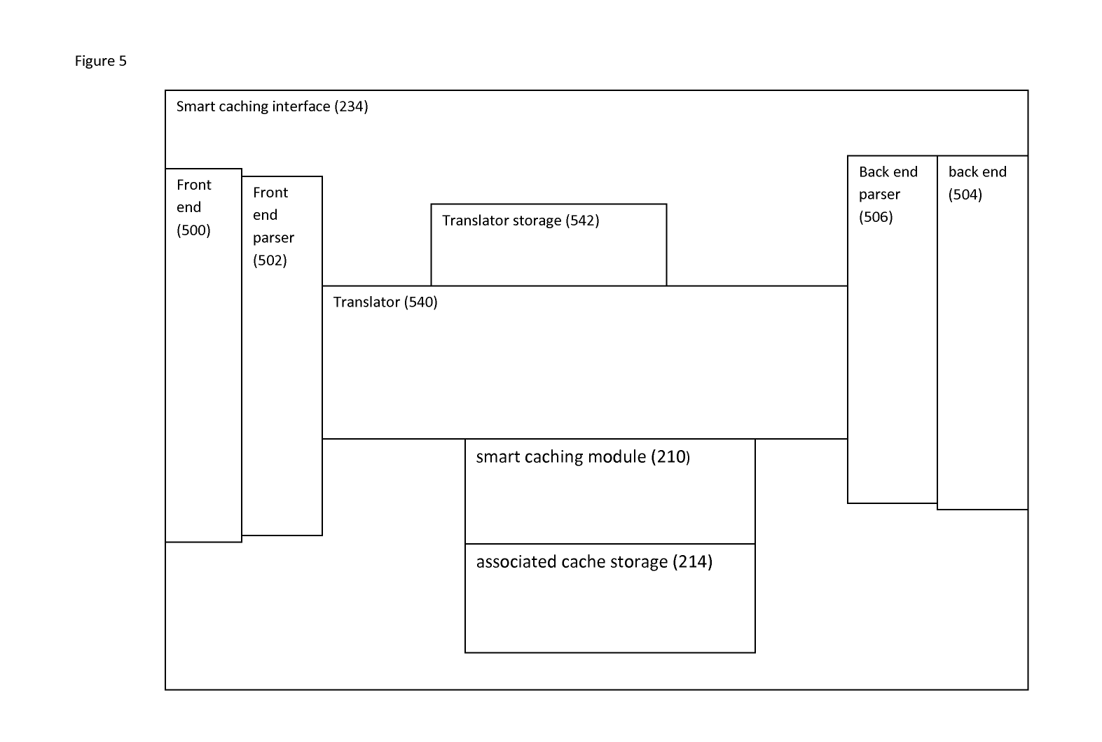

FIG. 5 describes an exemplary, illustrative system according to at least some embodiments of the present invention for translating different database protocols automatically at the smart caching interface (although of course it could also be implemented at the smart caching apparatus). The translating process and system may optionally be implemented as described with regard to the concurrently filed US Provisional Application entitled “Database translation system and method”, owned in common with the present application and having at least one inventor in common, which is hereby incorporated by reference as if fully set forth herein. All numbers that are identical to those in FIG. 2 refer to components that have the same or similar function.

As shown, smart caching interface 234 preferably features a front end 500, for receiving queries from an accessing application (not shown). The queries are optionally in a variety of different database protocols, each of which is preferably received by front end 500 at a different port or address (optionally there are a plurality of front ends 500, each of which is addressable at a different port or address). Front end 500 also preferably includes a front end parser 502, for packaging received data (results) in a format that can be transmitted to the requesting application.

Front end 500 preferably receives a query and then passes it to a translator 540, for translation to a format that can be understood by the receiving database. Translator 540 preferably translates the query to this format, optionally storing the original query in an associated translator storage 542. The translated query is then preferably passed to smart caching module 210, which preferably operates as described in FIGS. 3 and/or 4, to determine whether the query needs to be sent to the database (not shown). Smart caching module 210 preferably controls and manages storage of the raw query and results, and also the translated query and results, such optionally translation is not required of the received query before determining whether the results have been stored. For such an embodiment, optionally translator storage 542 is only used by translator 540 during the translation process, such that both the translated query and results are stored at associated cache storage 214.

Next, if a query needs to be sent to the database, smart caching module 210 preferably sends the translated request to back end 504, which more preferably features a back end parser 506 for packaging the translated query for transmission to whichever database protocol is appropriate.

The received results from the database are preferably then passed back to smart caching module 210, optionally through translation again by translator 540. The storage process may optionally be performed as previously described for the raw (untranslated) query and/or results, or for the translated query and/or results, or a combination thereof. The translated results are then preferably passed back to the requesting application by front end 500, more preferably after packaging by front end parser 502.

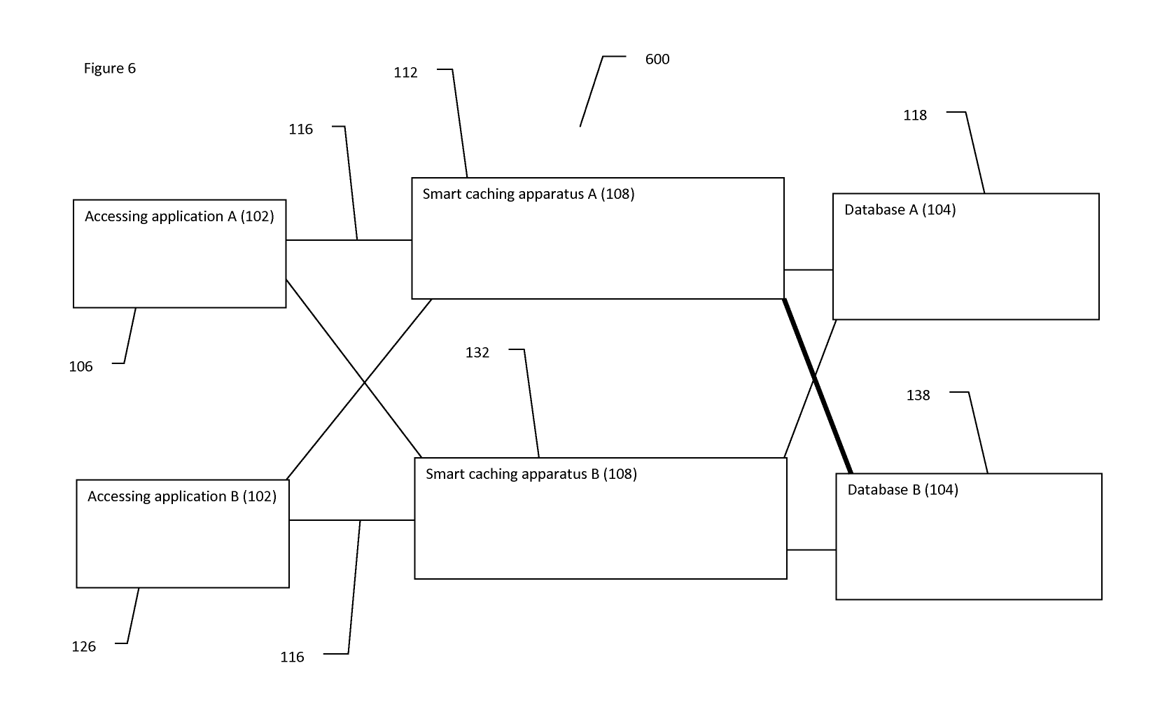

FIG. 6 shows an illustrative exemplary system for database mirroring according to at least some embodiments of the present invention. By “database mirroring” it is meant duplicating part or all of stored database information, in order to protect against unexpected loss of database functionality and also optionally to implement distributed database functionality, for example according to geographic location.

A system 600 is similar to that of FIG. 1; components having the same or similar function have the same reference numbers. A plurality of accessing applications 102 (shown as accessing applications A and B) communicate with databases A and B 104 as shown, through smart caching apparatuses A and B 108. Smart caching apparatuses A and B 108 are preferably implemented as for FIG. 1; not all components are shown for clarity. Smart caching apparatus A 108 is operated by computer 112, while smart caching apparatus B 108 is operated by computer 132.

As shown, each of smart caching apparatuses A and B 108 is preferably able to communicate with each of databases A and B 104. Similarly each of accessing applications A and B 102 is preferably able to communicate with each of smart caching apparatuses A and B 108. Such a configuration optionally enables one of smart caching apparatuses A and B 108 to be active while the other is passive, for example; alternatively, accessing applications A and B 102 may optionally be directed to and/or may optionally select one of smart caching apparatuses A and B 108, for example according to geographical location, desired level of service to be provided to each of accessing applications A and B 102, relative load on smart caching apparatuses A and B 108, source IP, user name, user location, reliability, identity of accessing applications A and B 102, and so forth.

Also optionally, smart caching apparatus A 108 may be active for certain situations, for example according to the type of data, the required database 104, geographical location, desired level of service to be provided to each of accessing applications A and B 102, relative load on smart caching apparatuses A and B 108, source IP, user name, user location, reliability, identity of accessing applications A and B 102, and so forth. However, in other situations, smart caching apparatus A 108 could be passive, for example to optionally provide back-up functionality for queries etc that would typically be handled by smart caching apparatus B 108.

Accessing application A 102 is operated by computer 106, while accessing application B 102 is operated by computer 126. Communication between computers 106 and 126, and computers 112 and 132, is preferably performed through network 116, which may optionally be a single computer network or a plurality of interconnected computer networks.

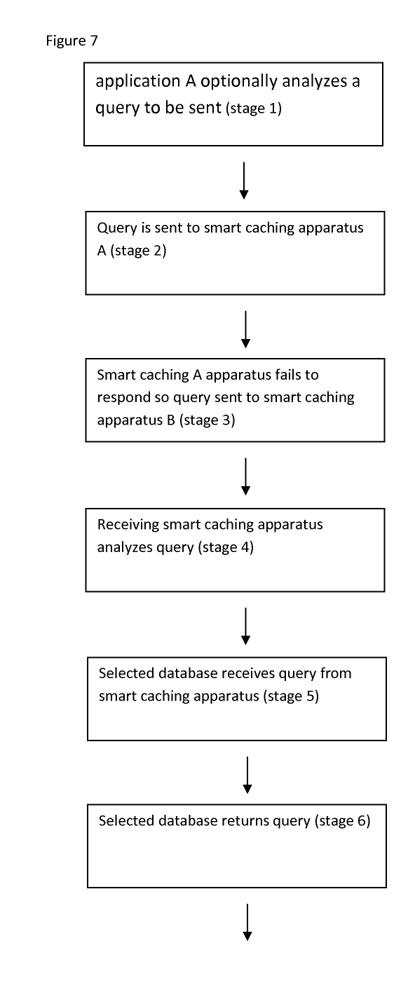

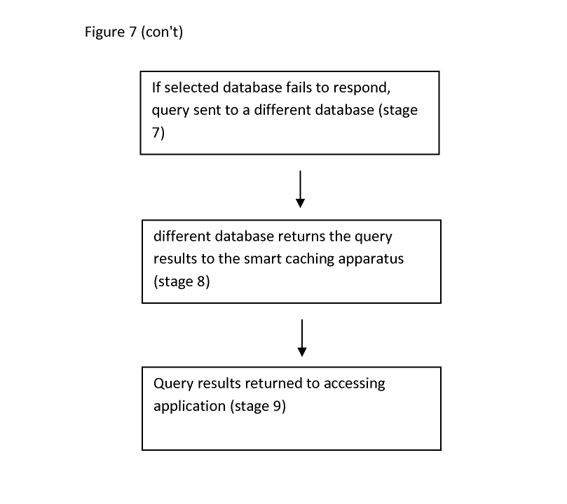

FIG. 7 is a flowchart of an exemplary method for database mirroring according to at least some embodiments of the present invention. The method may optionally be performed for example with regard to the system of FIG. 6. As shown, in stage 1, an application A optionally analyzes a query to be sent to a database. In stage 2, according to the outcome of the analysis, the query is sent to a smart caching apparatus A. Optionally, application A may not select a specific smart caching apparatus to which the query is to be sent, but rather performs a rule look-up to determine the appropriate IP address to which the query is to be sent. As previously noted, optionally application A is not aware of the smart caching apparatus as such, but rather uses the rule look-up to determine the appropriate addressing for the query.

In stage 3, if for some reason the transmission of the query to smart caching apparatus A fails, for example because smart caching apparatus A fails to respond, then the application may optionally transmit the query to smart caching apparatus B.

In any case, in stage 4, the receiving smart caching apparatus which is able to respond to the query optionally performs an analysis to determine which database, database A or database B, should receive the query. Again as previously described, the analysis may optionally consider one or more of such factors as geographical location, desired level of service to be provided to each of accessing applications A and B, relative load on smart caching apparatuses A and B (assuming that both are able to respond), source IP, user name, user location, reliability, identity of accessing applications A and B, and so forth.

In stage 5, the selected database receives the query from the smart caching apparatus. If the selected database is able to respond, then in stage 6, the selected database returns the query results to the smart caching apparatus. Otherwise, if the selected database is not able to respond, then in stage 7, the smart caching apparatus sends the query to a different database; the different database returns the query results to the smart caching apparatus in stage 8.

In stage 9, the received query results are sent from the smart caching apparatus to the accessing application.

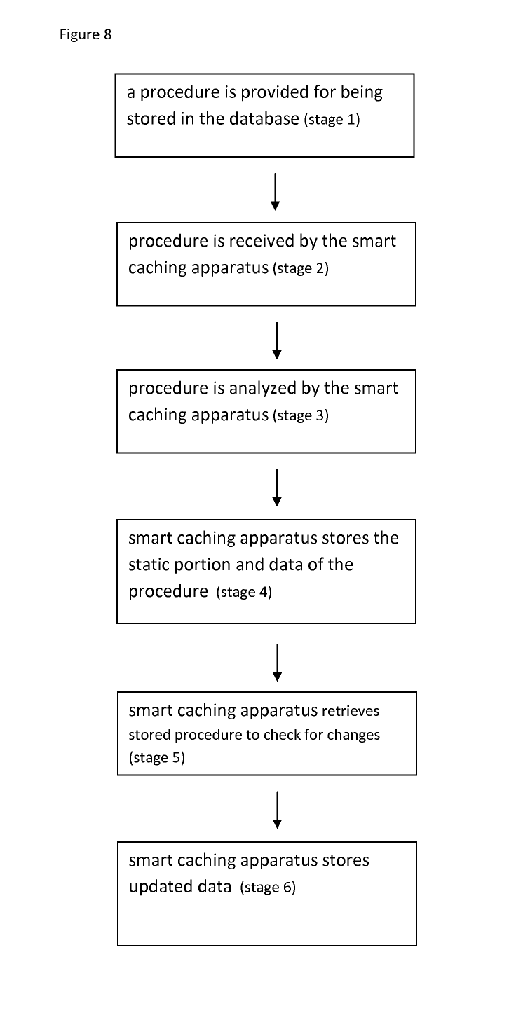

FIG. 8 is a flowchart of an exemplary method for dynamic process analysis according to at least some embodiments of the present invention. The method may optionally be implemented with regard to the systems of FIG. 1 or 6, for example.

As shown, in stage 1, a procedure is provided for being stored in the database. The procedure in this non-limiting example features dynamic and static portions; the procedure also draws upon information in one or more tables, also stored in the database.

In stage 2, the procedure is received by the smart caching apparatus, for example from an accessing application. In stage 3, the procedure is analyzed by the smart caching apparatus in order to identify the static and dynamic portions, and also which information/tables/columns from the database are required for the procedure.

In stage 4, the smart caching apparatus preferably stores the static portion of the procedure by sending it to the database, and also optionally either stores the data associated with the procedure by sending it to the database or indicates where in the database this data may be located (for example with one or more pointers) in order to reduce storage overhead. In stage 5, the smart caching apparatus optionally and preferably retrieves the procedure from the database to determine whether any changes have occurred to the data from the database related to the procedure and also optionally whether the dynamic part of the procedure has been changed (for example due to one or more other changes to other procedures). In stage 6, if in fact any change has occurred, the smart caching apparatus may optionally updated the above described stored data, but may alternatively flush the stored procedure so that it is no longer cached. Preferably stages 5 and 6 are performed frequently, although the preferred frequency may optionally be determined according to one or more administrative user preferences and/or according to the requesting application, for example.

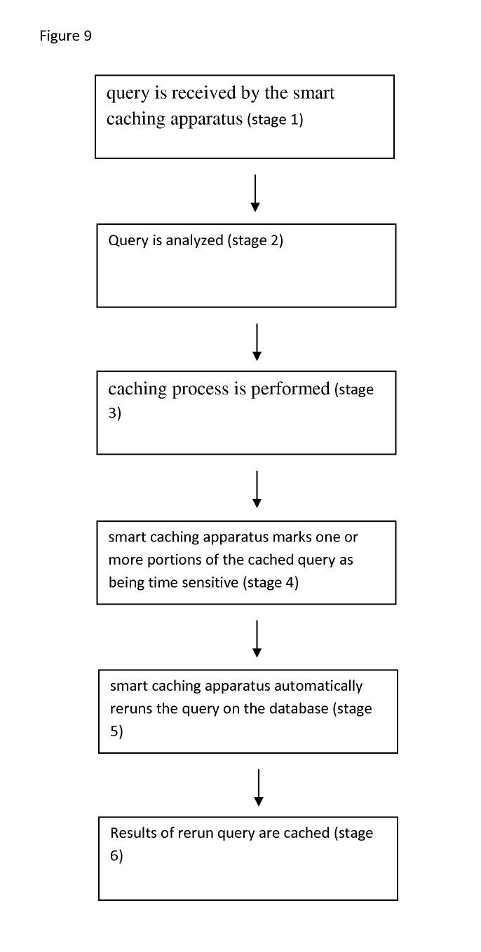

FIG. 9 is a flowchart of an exemplary method for automatic query updates according to at least some embodiments of the present invention.

As shown, in stage 1 a query is received by the smart caching apparatus. In stage 2, the query is analyzed by the smart caching apparatus to determine whether one or more portions are time sensitive. In stage 3, the caching process is performed as previously described. In stage 4, the smart caching apparatus marks one or more portions of the cached query as being time sensitive (stages 3 and 4 may optionally be performed in any order). In stage 5, the smart caching apparatus automatically reruns the query on the database, optionally even if an accessing application has not sent such a query again. In stage 6, the results of the rerun query are cached.

While the invention has been described with respect to a limited number of embodiments, it will be appreciated that many variations, modifications and other applications of the invention may be made.

1. A method for smart caching of data outside a database, comprising: intercepting a query for data by a smart caching apparatus; determining whether the requested data has been stored at said smart caching apparatus; if the requested data has been stored at said smart caching apparatus, providing the requested data by said smart caching apparatus; otherwise, passing said query to said database; marking the requested data as being retrieved data at said smart caching apparatus; if the requested data has not been stored, creating a hash of the requested data; if said hash matches a stored hash at said smart caching apparatus, determining whether to store the requested data.

2. (canceled)

3. The method of claim 1, further comprising: determining whether the requested data is to be stored according to at least one characteristic of the requested data and/or of said query.

4. The method of claim 3, wherein said at least one characteristic of said query relates to a characteristic of a query generating application that generates said query.

5. The method of claim 4, wherein said at least one characteristic of the requested data relates to a permanence of the requested data.

6. The method of claim 5, wherein said at least one characteristic of the requested data relates to available bandwidth between said smart caching apparatus and said query generating application.

7. (canceled)

8. The method of claim 6, wherein said determining whether to store the requested data comprises determining a period of time since said stored hash was stored.

9. The method of claim 1, further comprising: determining whether to store the requested data according to a number or rate of retrieval requests for the requested data and/or a time elapsed since the requested data has been last retrieved.

10. The method of claim 1, further comprising: determining a TTL (time to live) for stored data according to one or more of a number or rate of retrieval requests for the requested data and/or a time elapsed since the requested data has been last retrieved and/or a characteristic of the requested data.

11. The method of claim 10, further comprising: flushing said stored data after a predetermined period of time; and automatically transmitting a query associated with said stored data to said database to receive results associated with said query by said smart caching apparatus without waiting for transmission of said query by a query requesting application.

12. The method of claim 11, automatically storing results from said database of said automatically transmitted query at said smart caching apparatus.

13. The method of claim 12, further comprising: determining whether to store said results of said query according to a status of said database.

14. The method of claim 12, further comprising providing a plurality of databases; determining a status of at least one database; and selecting said database for storing said results of said query according to said status.

15. The method of claim 14, wherein said status of said database is determined according to one or more of a lack of database availability, an identity of a requesting application issuing said query, an IP address of said requesting application, a geographical location of a computer operating said requesting application, and a geographical location of said database.

16. The method of claim 15, wherein said lack of database availability comprises one or more of database restart, restore, or update.

17. The method of claim 16, further comprising: determining whether to flush stored results of a query according to said status of said database.

18. The method of claim 17, wherein said smart caching apparatus is integrated with said database.

19. The method of claim 18, wherein said smart caching apparatus is operated by the same hardware as said database.

20. The method of claim 19, further comprising before intercepting said query, generating said query by a query generating application; and sending said query by said query generating application to an address of said hardware, wherein said smart caching apparatus communicates with said database through a separate port than a port to which said query generating application sends said query.

21. The method of claim 1, wherein said smart caching apparatus is separate from said database.

22. (canceled)

23. The method of claim 1, further comprising: determining whether to translate a received query; and translating said received query, before determining whether results of said query are stored at said smart caching apparatus.

24-31. (canceled)
